(19) United States
(12) Patent Application Publication
(10) Pub. No.: US 2009/0302115 A1
(43) Pub. Date: Dec. 10, 2009

(54) Bar Code Obliteration System and Method

(75) Inventor: Paul Dowling, Hartfield, PA (US)

Correspondence Address: STRASBURGER & PRICE, LLP, 901 MAIN STREET, SUITE 4400, DALLAS, TX, 75202, US

(73) Assignee: Alan Ritchey, Inc.

(21) Appl. No.: 12/478,427

(22) Filed: Jun. 4, 2009

Related U.S. Application Data
(60) Provisional application No. 61/130,937, filed on Jun. 4, 2008.

(51) Int. Cl. G06K 7/10; B41J 2/335

(52) U.S. Cl. 235/462.01; 347/215

(57) ABSTRACT

A destination bar-coded label obliteration system and method causes a destination bar-coded label affixed to a collapsed collapsible cardboard sleeve to contact a rotating heating surface. Contact with the rotating heated surface causes black lines to form on the destination bar-coded label by activation of the heat sensitive ink used to cause the bar code to appear on the destination bar-coded label.

### CROSS REFERENCE TO RELATED APPLICATIONS

This application claims the benefit of Provisional U.S. Patent Application No. 61/130,937 filed Jun. 4, 2008.

### STATEMENT REGARDING FEDERALLY FUNDED RESEARCH AND DEVELOPMENT

The invention described in this patent application was not the subject of federally sponsored research or development.

### FIELD

The present invention pertains to labels on which identifying information, to include a bar code, is made to appear by thermal activation of heat sensitive ink covering the label; more particularly, the present invention pertains to the obliteration of bar-coded information caused to appear on a label by the application of heat to heat sensitive ink.

### BACKGROUND

Mail handling services, such as the U.S. Postal Service, move extremely large quantities of envelopes and packages all over the United States in a relatively short period of time. In an effort to keep up with the growing demand to move even greater quantities of envelopes and packages in less time, the U.S. Postal Service is continually exploring new ways of both automating its mail handling procedures and refining those mail handling procedures that are inefficient. For example, the once ubiquitous canvas mail bag is being replaced by easier-to-use mail trays or mail tubs. These mail trays or mail tubs are filled with sorted items such as envelopes addressed to a common destination. The sorted envelopes in the mail tray or mail tub are then covered by a collapsible cardboard sleeve for two reasons. First, the collapsible cardboard sleeve keeps the mailed items in the mail tray or mail tub when the collapsible cardboard sleeve is expanded to slide over the mail tray or mail tub. Second, the collapsible cardboard sleeve provides a surface for the affixation of a routing label bearing a bar code signifying a destination for the mail tray or mail tub. The destination bar code on the label affixed to the collapsible cardboard sleeve provides machine readable routing instructions for directing the mail tray or mail tub to another postal facility. Once the mail tray or mail tub together with its collapsible cardboard sleeve reaches the destination identified on the destination bar-coded label, the mail tray or mail tub and the cardboard sleeve are both recycled for re-use in sending a new batch of mailed items to another destination.

Because of the large number of mail trays, mail tubs and collapsible cardboard sleeves to be recycled by the U.S. Postal Service in large metropolitan areas such as New York, Philadelphia, Chicago and Los Angeles, the U.S. Postal Service has found it to be economical to use private businesses to sort, inspect, repair and size the various types of containers and collapsible cardboard sleeves used to hold and ship mail to its designated destination. After the containers and collapsible cardboard sleeves have been sorted, inspected, repaired and sized, they must be made ready for re-use by the U.S. Postal Service in a short period of time.

One key step in the processing of the collapsible cardboard sleeves on which the destination bar-coded labels are placed is the obliteration of the previously used destination bar code. The preferred prior art method of obliterating the bar-coded label is to cover the destination bar code with an opaque white label. Typically, such opaque white labels have a black, pressure sensitive adhesive backing. The black, pressure sensitive adhesive adheres to the already used label appearing on the collapsible cardboard sleeve. While the material cost of such opaque white labels is relatively low, the labor cost associated with manually placing the opaque white labels over used destination bar-coded labels is high. The high labor cost limits the number of collapsible cardboard sleeves that can be recycled for re-use in the required turn-around time.

If greater speed is necessary or the number of collapsible cardboard sleeves to be re-cycled in the desired turn-around time increases, the preferred prior art way of obliterating a destination bar code on the label placed on a collapsible cardboard sleeve used with a mail container is to create additional workstations for the manual attachment of opaque white labels over the used destination bar-coded labels on the collapsible cardboard sleeves.

If the level of mailed items drops, the business having the responsibility for obliterating the destination barcode on used labels may be left with the costly problems of unused recycling capacity for the collapsible cardboard sleeves and the necessity to pay an idle worker.

Accordingly, a need remains in the art for a more cost-efficient system and method which will speed up the process of obliterating a destination bar code imprinted on a destination bar-coded label which has been made to appear by using heat sensitive ink.

### SUMMARY

The system and method of the present invention eliminates the need for the manual obliteration of the destination bar codes on destination bar-coded labels coated with heat sensitive ink and enables faster obliteration of used destination bar-coded labels on the collapsible cardboard sleeves used with mail trays or mail tubs for directing mail to a desired location.

The system and method of the present invention includes at least one heated roller with an obliterating surface formed thereon. The collapsible cardboard sleeves with the destination bar-coded label imprinted thereon are fed through a set of driven entry feed and guide rollers. The driven entry feed and guide rollers direct the collapsible cardboard sleeve in a collapsed condition into a gap adjacent to a cylindrical heated roller. The surface temperature of the heated roller is sufficient to activate the heat sensitive ink on the destination bar-coded labels and thus cause at least one dark wide line to appear over the destination bar code. The presence of the dark wide line renders the destination bar code not machine readable or effectively obliterated.

A pair of driven exit feed and guide rollers positioned after the heated roller picks up the collapsible cardboard sleeve to continue the movement of the collapsed cardboard sleeve past the heated rollers.

The size of the heated roller is such that a destination bar-coded label may be obliterated in whatever location or orientation it appears on the collapsed cardboard sleeve.

### BRIEF DESCRIPTION OF DRAWING FIGURES

A still better understanding of the system and method of the present invention may be had by reference to the drawing figures wherein:

FIG. 1 is a perspective of a stack of collapsed cardboard sleeves wherein an unobliterated destination bar-coded label is shown affixed to the collapsed cardboard sleeve on the top of the stack;

FIG. 2 is a plan view of that portion of the surface of a used collapsed cardboard sleeve including a destination bar-coded label rendered unreadable by the manual placement of marks over the destination bar code;

FIG. 3 is a perspective view of a first embodiment of the present invention using a single heated roller;

FIG. 4 is a perspective of a second embodiment of the present invention including two heated rollers;

FIG. 5 is a perspective view similar to FIG. 4 but with a collapsed cardboard sleeve passing therethrough;

FIG. 6 is a perspective view of a third and preferred embodiment of the present invention;

FIG. 7 is a perspective view of the heated roller assembly used in the third and preferred embodiment shown in FIG. 6; and

FIG. 8 a perspective view of a collapsible cardboard sleeve including a label affixed to its surface having two partially blackened bands formed by the disclosed invention which obliterates the destination bar code.

### DESCRIPTION OF THE EMBODIMENTS

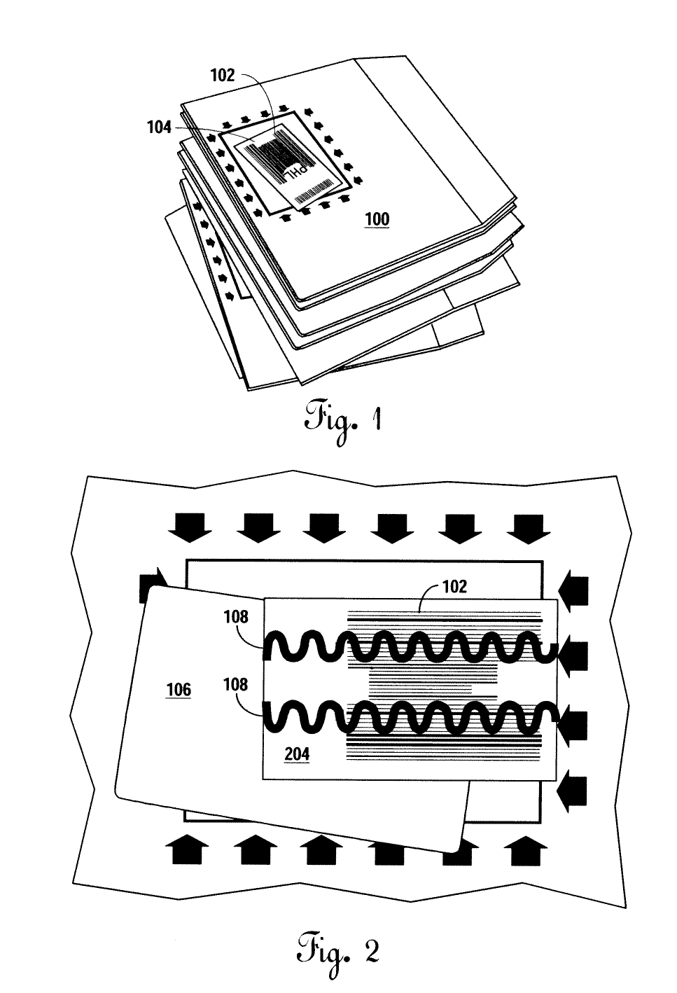

As indicated in the foregoing description of one method used by the US Postal Service for automating and thereby speeding up the sorting and flow of mail, FIG. 1 illustrates stack of a collapsed collapsible cardboard sleeves 100 that are placed over mail trays or mail tubs (not shown) containing envelopes or packages directed to a particular location. The white label 104 placed generally in an area on the collapsible cardboard sleeve marked by arrows contains a bar code 102 imprinted thereon by the use of thermally sensitive ink. Specifically, the label 104 is coated with the heat sensitive ink.

Those of ordinary skill in the art will understand that despite the plurality of black arrows imprinted on the collapsible cardboard sleeve, the placement of the labels 104 on the collapsible cardboard sleeve becomes somewhat random over time. When a blank label 104 is contacted by a heated imprinting device, the heated portions of the heat sensitive ink on the label turn black thereby making the bar code 102 visible along with any other identifying or routing information needed to direct the mail tray or mail tub to its proper destination. The label 104 in FIG. 1 includes the letters PHL indicating that the destination bar code 102 on the cardboard sleeve 100 signaled an optical reader on an automatic processing device (not shown) to direct the mail tray or mail tub on which the cardboard sleeve 100 was located to a US Postal Service facility in the city of Philadelphia.

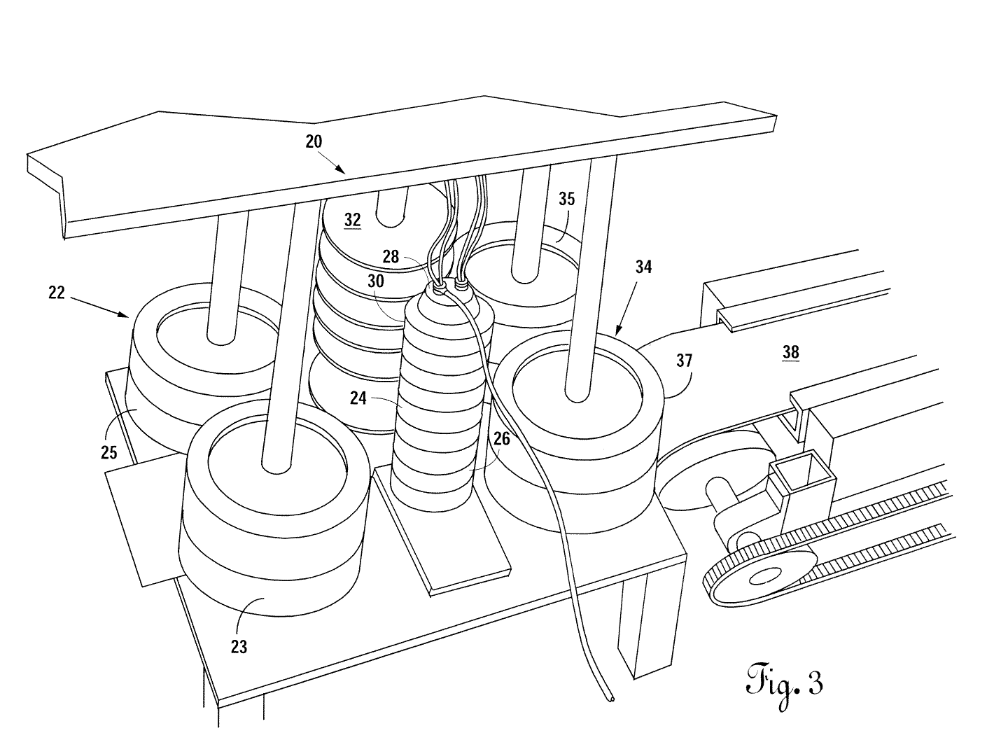

When the tray or tub with mail contained therein reaches a US Postal Service facility at the prescribed destination, for example—Philadelphia, the combination of the collapsible cardboard sleeve 100 and the destination bar-coded label 104 have done their job. However, the collapsible cardboard sleeve 100 is reusable and can be placed around another tub or tray of mail and with a new destination bar-coded label affixed thereto for redirection of a mail tray or mail tub to another US Postal Service facility. As explained in the Background portion, above, one prior art method accepted by the US Postal Service is the placement of an opaque white label 106 (FIG. 2) over the used bar code label. The operation of manually placing an opaque white label 106 over the used bar code label is limited by the hand speed of the worker and is subject to error because of the repetitive nature of the work. When the collapsible cardboard sleeve 100 is ready for re-use, another destination bar-coded label 204 is placed over the opaque white label 106.

An alternative method of obliterating the used destination bar-coded label is also shown in FIG. 2. Specifically, the destination bar code is made unreadable by the use of a dark are a placed over the destination bar-coded label using a marker. These marks render the bar code 102 unreadable or effectively obliterated.

A first embodiment of a machine 20 which forms dark bands 108 across a destination bar-coded label 104 (as shown in FIG. 8) made with heat sensitive ink appears in FIG. 3. Moving from left to right in the drawing figure, a driven entry feed and guide roller assembly 22 may be seen. The entry feed and guide roller assembly 22 including a pair of driven rollers 23, 25, grabs the collapsed collapsible cardboard sleeve 100 and moves it horizontally from left to right in FIG. 3. In the center of the machine 20 is a stack 24 of roller bearings 26. Inside the stack of roller bearings 24 is a heating element 28. The heating element within the stack of roller bearings 24 raises the temperature at the surface 30 of each roller bearing 26 to about 200° Fahrenheit. This surface temperature is sufficient to activate the heat sensitive ink on the destination bar-coded label 104 but will not burn, scorch or destroy the surface of the collapsible cardboard sleeve 100.

When the heat sensitive ink on the destination bar-code label 104 comes into contact with the heated surface 30 of each roller bearing 26, one or more 26 dark bands 108 (as shown in FIG. 8) are formed across the destination bar-code label 104 which contacts heated surface 30 because of the reaction of the heat sensitive ink to heat. Contact of the destination bar-code label 104 with the surface 30 of a heated roller bearing 26 is assured by an idler roller 32. The space between the idler roller 32 and the stack 24 of heated roller bearings 26 is set to accommodate both thin collapsed collapsible cardboard sleeves 100 and thick collapsed collapsible cardboard sleeves 100.

Following the stack 24 of heated roller bearings 26 is a driven exit feed and guide roller assembly 34. The exit feed and guide roller assembly 34 including driven rollers 35, 37 contact the leading end of the cardboard sleeve assure its complete passage through the machine 20. Following the exit feed and guide roller assembly 34 is a conveyor assembly 38 to carry the collapsed collapsible cardboard sleeves to a location where they can be re-labeled. As will be understood by those of ordinary skill in the art, the first embodiment of the present invention shown in FIG. 3 requires that all collapsed collapsible cardboard sleeves run through the machine 20 with the destination bar-code label 104 on the same side to enable contact with heated surface 30. Those of ordinary skill in the art will also understand that other means for moving the collapsed cardboard sleeves may be used. Such means may include pushing on the edge of the collapsed cardboard sleeve a moving clamp which contacts the sides of the collapsed cardboard sleeve to enable linear motion past the heated rollers or a suction apparatus which makes temporary contact with the collapsed cardboard sleeves.

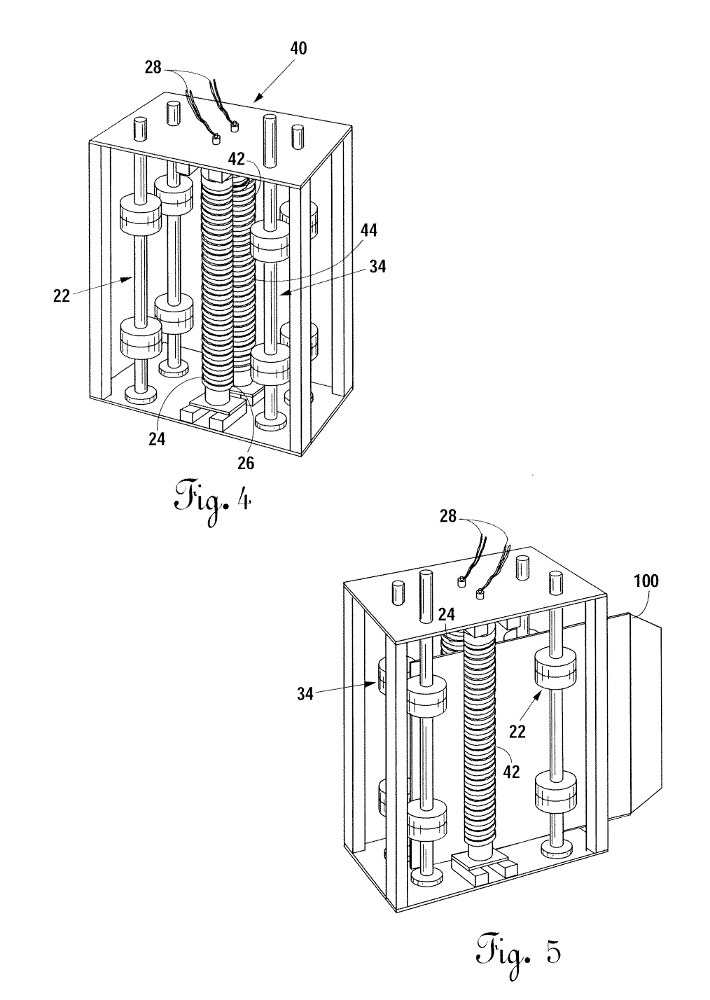

In the second embodiment 40 of the machine shown in FIGS. 4 & 5, the idler roller 32 (shown in FIG. 3) has been replaced by a second stack 42 of heated roller bearings 44 just like the stack 24 of heated roller bearings 26 which appears in the embodiment shown in FIG. 3. Thus, by use of the machine described by the second embodiment 40 shown in FIGS. 4 & 5 there is no need for assuring that all of the cardboard sleeves 100 are oriented with the destination bar-coded label facing in the same direction.

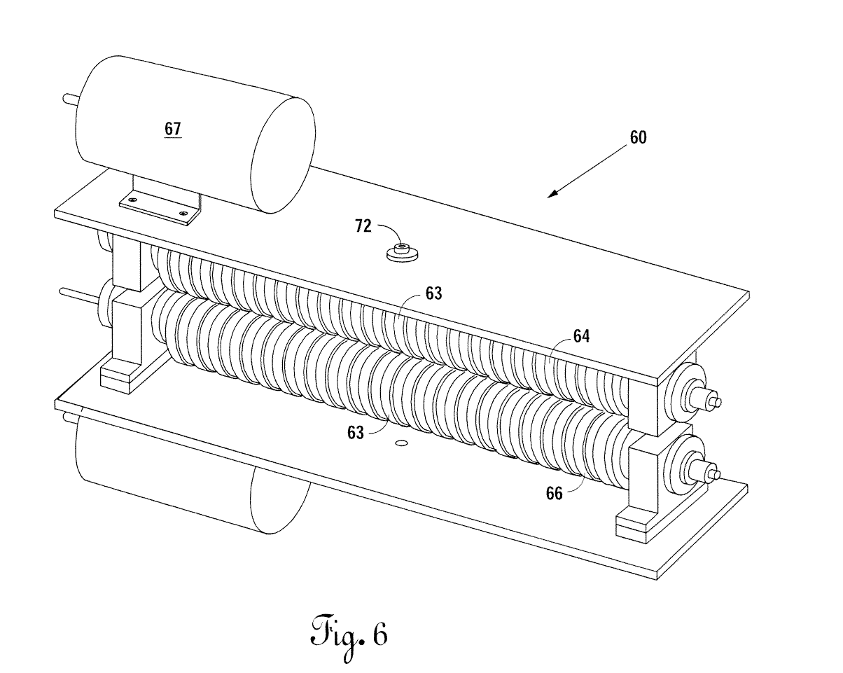

FIG. 5 illustrates a cardboard sleeve 100 passing through the two stacks 24, 42 of heated roller bearings 26, 44.

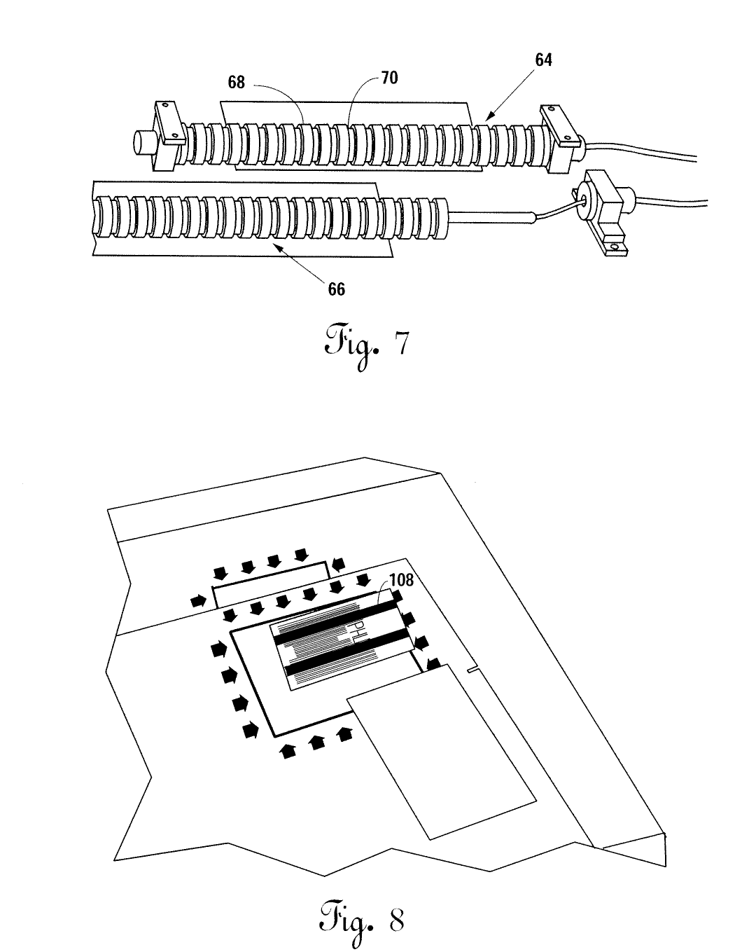

FIG. 6 is a perspective view of the third and preferred embodiment 60 of the present invention. In this embodiment 60 the driven rollers used before and after the stack of heated roller bearings have been eliminated. In their place are two horizontally oriented heated rollers 64, 66 such as those which appear in FIG. 7. As shown in FIG. 6 both rollers are driven by a motor 67, preferably an electric motor and a mechanical drive combination. Each horizontally oriented heated roller 64, 66 has a plurality of label contact surfaces 68 formed thereon and spaces 70 formed therebetween. Because the key operating parameter has been found to be the surface temperature on the outside of the rollers at the surface 68 where contact is made with the destination bar-coded label 104 an IR temperature monitoring probe mounted in an opening 72, as used in the preferred embodiment, is used to provide a signal representative of the surface temperature of the horizontally oriented heated rollers 64, 66 to a control circuit. The control circuit governs the amount of electrical power provided to the heater within the rollers to assure that the surface 68 of each roller 64, 66 is kept at a temperature which will activate the heat sensitive ink thereby causing obliterating marks to appear on the bar code label 104 as shown in FIG. 8.

While two dark bands 108 appear on the bar code label 104 shown in FIG. 8, it has been found that even if the dark bands 108 are not solid all the way across the bar code as shown in FIG. 8, even a partial dark band 108 will disrupt the machine readability of the bar code 102 thereby effectively rendering the destination bar-coded label 104 unreadable an optical scanner. This discovery has enabled increasing the processing speed of the disclosed invention far beyond what has previously been done by the manual placement of an opaque white label over the used destination bar-coded label on each collapsible cardboard sleeve 100 as shown in FIG. 2.

Those of ordinary skill in the art will understand that the disclosed label obliteration system and method of the present invention may be further enhanced by the use of an automatic feed system which positions the collapsible cardboard sleeves 100 for passage by and contact with the heated surfaces which contact the destination bar-coded label 104. Further, an automated obliterated label checking system may be placed downstream from the heated surfaces. This automated checking system attempts to read each destination bar-coded label 104. If the bar code on the destination bar-coded label can be read, then the used destination bar-code label has not been effectively obliterated and the collapsible cardboard sleeve 100 is classified as a reject. Rejected collapsible cardboard sleeves are not recycled for re-use with a mail tray or mail tub. If the destination bar-coded label cannot be read the collapsible cardboard sleeve 100 is accepted. Accepted collapsible cardboard sleeves placed into an automatic stacking system and restored to the mail system for re-use.

While the present invention has been described and illustrated according to its preferred and alternate embodiments, those of ordinary skill in the art will understand that still other embodiments will become apparent to those of ordinary skill in the art once having gained an understanding of the foregoing disclosure.

What is claimed is:

1. A method of obliterating a bar code imprinted by the use of thermally sensitive ink on a label, said label being located on a piece of cardboard, said method comprising the steps of:
grabbing the piece of cardboard with powered rollers;
causing the label to contact rotating heated surfaces to cause darkened marks to appear over the bar code;
directing the piece of cardboard away said rotating heated surfaces.

2. A method of obliterating a bar code imprinted on a label by the presence of thermally activated ink, said destination bar-coded label being located on a collapsible cardboard sleeve, said method comprising the steps of:
grabbing a collapsed collapsible cardboard sleeve with powered rollers;
passing said collapsed collapsible cardboard sleeve through a pair of rotating heating surfaces;
directing the collapsed collapsible cardboard sleeve away from said pair of rotating heated surfaces;
whereby darkened marks appear over the barcode rendering it unreadable by an optical scanner.

3. A method of obliterating a destination bar code imprinted on a label by the presence of thermally activated ink, said destination bar-coded label being located on a collapsible cardboard sleeve, said method comprising the steps of:
passing said collapsed collapsible cardboard sleeve through a pair of rotating heated surfaces;
monitoring the temperature of the surface of the pair of rotating heated surfaces;
adjusting the temperature of the surface of the pair or rotating heated surfaces;
reading the destination bar code imprinted on the label after passing through the rotating heated surfaces;
rejecting those collapsed collapsible cardboard sleeves where the destination bar code is readable by an optical scanner.

4. A system for obliterating a destination bar code on a destination bar-coded label affixed to a cardboard sleeve wherein the destination bar code is imprinted by applying heat to heat sensitive ink on the label, said system comprising:
a first pair of powered rollers positioned closer enough together to first grab and then move the cardboard sleeve with a destination bar-coded label affixed thereto through said first pair of powered rollers;
a pair of heated rollers following said first pair of powered rollers so that a sufficient amount of heat may be applied to said destination bar-coded label to create a marking using the heat sensitive ink which obliterates the destination bar code on the destination bar-coded label;
a second pair of powered rollers positioned close enough to grab and then move the cardboard sleeve with the obliterated destination bar-coded label affixed thereto through said second pair of powered rollers.

5. A destination bar-coded label obliteration machine for use with collapsible cardboard sleeves placed around mail trays or mail tubs bearing a destination bar-coded label imprinted by the use of heat sensitive ink, said destination bar-coded label obliteration machine comprising:
a pair of cylindrical heated rollers;
means for feeding the collapsible cardboard sleeves in a collapsed condition to said pair of cylindrical heated rollers so that said pair of cylindrical heated rollers come into contact with the destination bar-coded label imprinted by the use of heat sensitive ink for a period of time long enough to render destination bar code on said destination bar-coded label unreadable by an optical scanner;
means for pulling the collapsible cardboard sleeves away from said pair of cylindrical heated rollers after the destination bar code on said destination bar-coded label has been in contact with said pair of cylindrical heated rollers.

6. The machine as defined in claim 5 wherein said pair of cylindrical heated rollers include a plurality of heated cylindrical bearings stacked one on top of another.

7. The machine as defined in claim 6 wherein the machine includes an optical scanner positioned after said means for pulling the collapsible cardboard sleeves to determine if the destination bar code is machine readable.

8. The machine as defined in claim 7 wherein the machine further includes a device for separating out those collapsible sleeves which have moved past the heated cylindrical bearings without the destination bar code on the destination bar-coded label being rendered unreadable.
